(19) United States
(12) Patent Application Publication
(10) Pub. No.: US 2024/0192325 A1
(43) Pub. Date: Jun. 13, 2024

(54) OPTICAL ARRANGEMENT FOR LIGHT DETECTING SYSTEM

(71) Applicant: IRIDESENSE, Issy-les-Moulineaux (FR)

(72) Inventor: Scott Buchter, Espoo (FI)

(73) Assignee: IRIDESENSE, Issy-les-Moulineaux (FR)

(21) Appl. No.: 18/556,597

(22) PCT Filed: Apr. 22, 2021
(86) PCT No.: PCT/EP2021/060598

§ 371 Date: Oct. 20, 2023

(51) Int. Cl. G01S 7/481; G01S 7/484

(52) U.S. Cl. CPC G01S 7/4814; G01S 7/4812; G01S 7/4817; G01S 7/4818; G01S 7/484

(57) ABSTRACT

The invention provides an optical arrangement for a light detecting system, the optical arrangement being configured:
to steer an illumination beam along an illumination optical path from a laser source to a target to be sensed, in a transmitting direction, and
to transmit a reflected beam along a return optical path from the target to an optical detector, in a receiving direction, wherein the reflected beam comprises a reflection of the optical beam on the target,
the optical arrangement comprising a dichroic beamsplitter and a multi-clad optical fiber.

### TECHNICAL FIELD

The invention relates to optical arrangements for light detecting systems, and more particularly, to optical arrangements comprising a multi-clad fiber.

### BACKGROUND

Light detecting systems are used to illuminate an object and to detect a return light from said object, for instance in Light detection and ranging (LIDAR), spectrometer or imaging applications, for instance microscopy imaging.

### Technical Problem

For such light detecting systems, there is a need to generate a sufficient light power in order to enable a part of the illumination light which is returned to be detected.

Such a constraint traditionally leads to bulky optical arrangements, because of the use of a number of optical components, such as amplification stages and optical isolators, on both an illumination optical path and a return optical path.

### SUMMARY

Compared to the state of the art, it is proposed an optical arrangement which overcome the deficiencies of the prior art.

The invention provides an optical arrangement for a light detecting system, the optical arrangement being configured:
to steer an illumination beam along an illumination optical path from a laser source to a target to be sensed, in a transmitting direction, and
to transmit a reflected beam along a return optical path from the target to an optical detector, in a receiving direction, wherein the reflected beam comprises a reflection of the illumination beam on the target.

The term “illumination beam” shall be construed as the complete beam running along the complete illumination optical path from the laser source to the target, whatever the spectral content therein.

The optical arrangement comprises:
a transceiver arrangement comprising a dichroic beamsplitter, the transceiver arrangement being configured for:
transmitting a source beam from the laser source to a first end of an optical fiber arrangement, in one way selected among: through or by reflection on the dichroic beamsplitter, and
transmitting the reflected beam from said first end of the optical fiber arrangement to the optical detector in the other way selected among: through or by reflection on the dichroic beamsplitter,
the optical fiber arrangement comprising a multi-clad optical fiber which comprises a core, at least one inner cladding, and an outer cladding; wherein
said core is arranged to receive the source beam having a first wavelength, such that the source beam propagates in the core in said transmitting direction, and
the core is further configured to generate a scanning beam from the source beam (11a) propagating in the core, wherein the scanning beam comprises at least a second wavelength which is different from the first wavelength, and
said at least one inner cladding is configured to receive the reflected beam, comprising the at least second wavelength, such that the reflected beam propagates in the inner cladding in said receiving direction,
a scanning unit optically coupled to a second end of the optical fiber arrangement, the scanning unit being configured to steer the scanning beam to said target, and to receive the reflected beam from the target.

In the optical arrangement, the illumination optical path and the return optical path share a common optical path portion by use of the multi-clad fiber. In other words, the return path is monolithically integrated in the architecture.

The term “source beam” designates the part of the illumination beam which has not been modified by the core of the multi-clad optical fiber. The term “scanning beam” designates the part of the illumination beam which results from the modification of the source beam by the core of the multi-clad optical fiber. In other words, the core transforms the source beam into the scanning beam.

Such an architecture has various advantages.

For instance,
the optical alignment is eased. Indeed, when the scanning beam is collimated, the return signal alignment is automatically perfect.
a free-space pumping allows detection of the return signal,
the arrangement is polarization independent, so there is no polarization loss.
The use of a fiber removes the need of aperturing, which enables 100% of the return signal to be usable.
there is no need of multiple amplification stages,
there is no need of multiple isolators because the amplified spontaneous emission (ASE) noise is very low,
the number of optical components is lowered compared to traditional architectures, which enables the optical arrangement to be lighter and more compact,
the X-talk may be lowered between the first wavelength component and counterpropagating second wavelength component.

Such an architecture may be advantageous for various applications, such as for medical or LIDAR applications.

Such an optical arrangement may comprise one or more of the features below described, or any combination thereof.

There are a variety of source beams features which may be selected for the optical arrangement. For instance, in embodiments, the source beam may be a continuous wave (CW) beam, as for instance a frequency modulation continuous wave (FMCW). By contrast, in embodiments, the source beam is a pulsed laser beam. For instance, the pulses of the source beam have a rate of 500 KHz.

The optical arrangement may be provided in various manners. In embodiments, the optical arrangement may be provided uncoupled with a laser source and/or to an optical detector. In embodiments, the optical arrangement comprises the laser source. In embodiments, the optical arrangement comprises the optical detector.

In embodiments, the source beam at the first end of an optical fiber arrangement is a monochromatic pulsed beam centered on the first wavelength, and having a full width at half maximum (FWHM) lower as 10 nm, preferably lower as 1 nm.

In embodiments, the at least second wavelength is shifted from the first wavelength by at least 300 nm.

In embodiments, the shifting is performed by Raman effect in the multi-clad fiber.

In embodiments, the first wavelength is 1064 nm.

In embodiments, the dichroic beamsplitter has a high transmittance (HT) for wavelength higher as 1100 nm and a high reflectivity for wavelengths lower as 1100 nm.

In embodiments, the core is further configured to generate a supercontinuum in a range comprising the second wavelength.
In embodiments, the multi-clad optical fiber is a double-clad fiber.
In an embodiment, the core mode field diameter (MFD) is 11 μm. In another embodiment, the core MFD is a 20 μm and has a graded index and an aperture lower as 1.
In embodiments, the inner cladding has a diameter higher or equal to 100 μm.
In embodiments, the multi-clad fiber is 10 meters long.

In embodiments, the supercontinuum comprises at least the spectral range [1450 nm-1650 nm], preferably a larger spectral range, such as for instance [1400 nm-1700 nm].

Indeed, wavelengths below 1400 nm may be dangerous for eye safety.

In embodiments, the multi-clad optical fiber is selected such that a ratio of a P×L/D is above a threshold equal to 250 W, wherein P denotes for a power peak of light of the monochromatic pulsed beam at one end of the multi-clad fiber, L denotes for a length of the multi-clad optical fiber, and D denotes for the diameter of the core of the multi-clad optical fiber.

In embodiments, the optical arrangement further comprises a notch filter or a wavelength bandpass filter arranged on the return optical path.

In embodiments, the notch filter or the wavelength bandpass filter is wavelength-tunable.

In embodiments, the notch filter or the wavelength bandpass filter are further configured to successively tune the wavelength to different wavelength values selected in the range of the supercontinuum. Thanks to these features, the reflected beam can be filtered in a wavelength-selective manner, such that a spectral response of the target may be detected by a spectral scanning.

In embodiments, the optical detector is a unique broadband optical detector.

In embodiments, the optical fiber arrangement further comprises an amplifying optical fiber coupled to the multi-clad optical fiber, such that the laser beam propagates in the amplifying optical fiber, wherein the amplifying optical fiber is configured to optically amplify the laser beam propagating in said amplifying optical fiber such that a ratio between an unamplified power peak and an amplified power peak of the laser beam is higher than 10, preferably higher than 1000.

In an embodiment, the unamplified power peak may be in the range [50 mW-500 mW], and is amplified up to a power peak in the range [1 W-10 KW], preferably [100 W-10 KW].

In embodiments, the amplifying optical fiber and the multi-clad optical fiber are optically coupled by a welding of the first end of the multi-clad fiber with an end of the amplifying optical fiber, in order to form a single optical fiber.

In embodiments, the amplifying optical fiber may be a ytterbium-doped fiber. In embodiments, the amplifying optical fiber may be optically pumped, for instance by a 60 mW optical power. In embodiments, the amplifying optical fiber may be 5 meters long. In embodiments, the amplifying optical fiber may be either a simple clad fiber, or preferably a double clad fiber. In embodiments, the amplifying optical fiber may be arranged between the transceiver arrangement and the multi-clad optical fiber. In embodiments, the amplifying optical fiber is configured to amplify the first wavelength.

In embodiments, the light detecting system is a light detecting and ranging (LiDAR) system. For instance, the scanning unit may be configured to spatially scan areas in a spatial range comprised between 1 m and 1 km.

The invention namely provides an optical arrangement for a LIDAR, the optical arrangement being configured:
to steer an illumination beam along an illumination optical path from a laser source to a target to be sensed, in a transmitting direction, and
to transmit a reflected beam along a return optical path from the target to an optical detector, in a receiving direction, wherein the reflected beam comprises a reflection of the illumination beam on the target,
the optical arrangement comprising:
a transceiver arrangement comprising a dichroic beamsplitter, the transceiver arrangement being configured for:
transmitting a monochromatic pulsed source beam from the laser source to a first end of an optical fiber arrangement, in one way selected among: through or by reflection on the dichroic beamsplitter, and
transmitting the reflected beam from said first end of the optical fiber arrangement to the optical detector in the other way selected among: through or by reflection on the dichroic beamsplitter,
the optical fiber arrangement comprising a multi-clad optical fiber which comprises a core, at least one inner cladding, and an outer cladding; wherein
said core is arranged to receive the pulsed source beam such that the source beam propagates in the core in said transmitting direction, and
the core is further configured to generate a supercontinuum scanning beam from the pulsed source beam propagating in the core, and
said at least one inner cladding is configured to receive the reflected beam, such that the reflected beam propagates in the inner cladding in said receiving direction,
a scanning unit optically coupled to a second end of the optical fiber arrangement, the scanning unit being configured to steer the scanning beam to said target, and to receive the reflected beam from the target. In other words, the illumination beam is transformed while propagating in the core from monochromatic to supercontinuum.

The invention also provides a vehicle comprising a LiDAR system comprising an optical arrangement as described hereinabove.

The invention further provides the optical arrangement hereinabove described, but used for another kind of light detecting system than a LIDAR.

For instance, the optical arrangement is used in a spectral analysis and/or imaging system, for instance for microscopy and/or medical imaging. In such arrangement, the scanning unit may comprise a microscope head. For instance, the microscope head may be configured to be displaced in a step-by-step manner in order to spatially scan a two or a three-dimensional area. For instance, the area has a length of an order of magnitude of 0.5 cm, 1 cm or 5 cm.

The optical arrangement may also be used in Optical Coherence Tomography (OCT) systems. For instance, the OCT system may use a mode-locked laser as a laser source. For instance, the pulse repetition rate is in the order of magnitude of 10 MHz.

### BRIEF DESCRIPTION OF THE DRAWINGS

Other features, details and advantages will be shown in the following detailed description and on the figures, on which:

FIG. 1 is a functional schematic of a LiDAR comprising an optical arrangement according to an embodiment.

FIG. 2 is a functional schematic of a double-clad optical fiber used in the LiDAR of FIG. 1.

FIG. 3 is a functional schematic of a LIDAR comprising an optical arrangement according to an embodiment, with schematics of the spectra at different stages of propagation of light.

FIG. 4 represents a variant for a transmitter module for the optical arrangement of FIG. 1.

FIG. 5 is a functional schematic of an imaging device for medical applications, comprising an optical arrangement according to a variant.

### DETAILED DESCRIPTION

Figures and the following detailed description contain, essentially, some exact elements. They can be used to enhance understanding the invention and, also, to define the invention if necessary.

For the sake of conciseness, the elements which are similar or equivalent through the description will be described with reference to the same reference numbers.

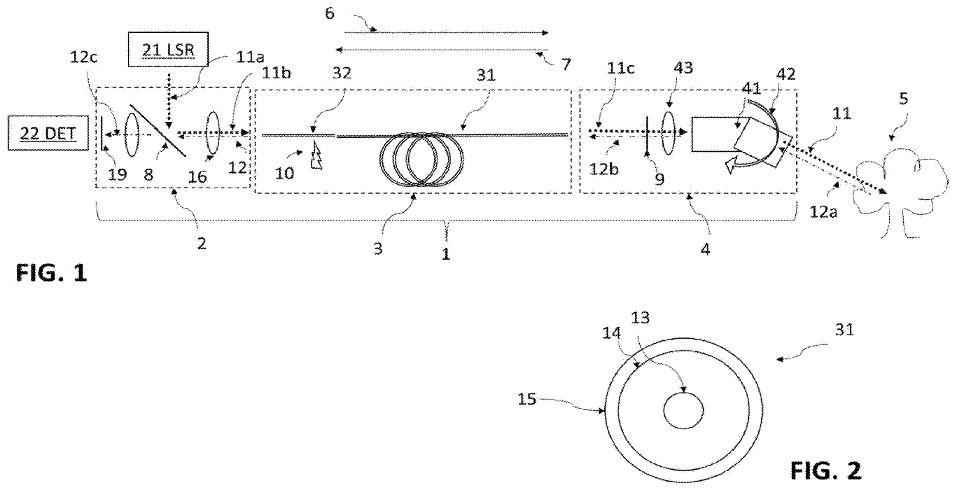

FIG. 1 represents an optical arrangement 1 used in a LIDAR (Light Detection and Ranging System) for sensing a target 5.

The LiDAR includes a laser source 21, and an optical detector 22, which may comprise an optical sensor or a plurality of optical sensors. The laser source 21 emits scanning pulses.

When a scanning pulse is reflected by the target 5, the LiDAR can determine the distance based on the time of flight of a return pulse received by the optical detector 22.

The LiDAR namely comprises the optical arrangement 1 for transmitting the scanning pulse from the laser source 21 to the target 5, and for transmitting the return pulse back from the target 5 to the detector 22.

In the following, the optical arrangement 1 will be described in more details.

The optical arrangement 1 comprises at least a transceiver arrangement 2, an optical fiber arrangement 3, and the scanning unit 4 as pictured on FIG. 1.

The scanning unit 4 is configured to steer the scanning pulse 11 in an orientable direction to the target 5 and to receive the return pulse 12 from the target 5 from said orientable direction.

The optical fiber arrangement 3 is configured to route the scanning pulse 11 from the laser source 21 to the scanning unit 4, and to route a return pulse 12 back through the double-clad fiber 31 to the detector 22. In other words, the scanning pulse 11 and the return pulse 12 share a same portion of optical path in two opposite directions, which will be further referred to as a scanning direction 6, and a sensing direction 7.

The transceiver arrangement 2 is configured to split in free space the optical paths of the scanning pulse 11 and the return pulse 12 in two non colinear optical paths corresponding to the optical path from the laser source 21 and the optical path to the optical detector 22. Such a splitting is performed by means of a dichroic beamsplitter 8, which is highly reflective (HR) for the wavelength of the scanning pulse 11 and highly transmittive (HT) for the return pulse 12.

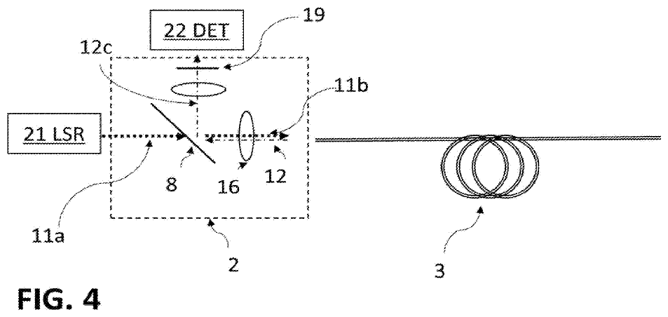

On the example pictured, the dichroic beamsplitter 8 is disposed with an angle of 45° by contrast with an output of the laser source 21, such that the scanning pulse 11 is deviated by an angle of 90° up to the optical fiber arrangement 3, whereas the return pulse 12 is not deviated on its travel to the optical detector 22, such that the optical paths are split in perpendicular optical paths 11a and 12c. One can see on FIG. 4 that in a variant, the configuration may be exactly inversed by selecting an inverse beamsplitter 8 in order that the scanning pulse 11 is not deviated, whereas the return pulse 12 is.

One can provide a filter 19 between the beamsplitter 8 and the detector 22 in order to improve the spectral sensing of the return light.

A coupling lens 16 is arranged on the optical path 11b between the dichroic beam splitter 8 and the optical fiber arrangement 3, in order to collimate the laser light in both the scanning direction 6 and the sensing direction 7 from the free space to the optical fiber arrangement 3.

The optical fiber arrangement 3 comprises a double-clad optical fiber (DCF) 31 which will be described more in references with FIG. 2, and an amplifying fiber 32.

A DCF is an optical fiber with a structure consisting of three layers of optical material instead of the usual two. As one can see on FIG. 2, the inner-most layer is a core 13. The core 13 is surrounded by an inner cladding 14, which is surrounded by an outer cladding 15. The three layers are made of materials with different refractive indices.

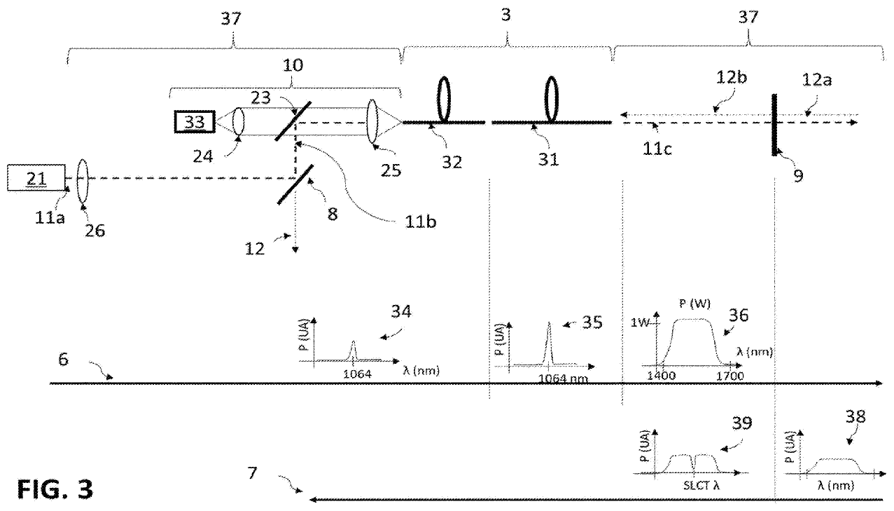

As one can see on FIG. 3, the spectrum shape of the scanning pulse 11 is transformed while traveling along the scanning direction 6, at different stages of propagation.

One can see on the figure different optical paths portions 11a, 11b and 11c for the scanning direction 6, and different optical paths portions 12a and 12b for the sensing direction 7.

The optical path portion 11a is the portion of the optical path comprised between the laser source 21 and the beamsplitter 8. The optical path portion 11b is the portion of the optical path comprised between the beamsplitter 8 and the optical fiber arrangement 3. The optical path portion 11c is the portion of the optical path comprised between the optical fiber arrangement 3 and the output of the scanning unit 4.

The optical path portion 12c is the portion of the optical path comprised between the optical fiber arrangement 3 and the optical detector 22.

One can see schemes 34, 35 and 36 of the spectrum of the scanning beam 11 for each stage of propagation through the optical path in the transmitting direction 6.

The laser source 21 is configured such that the scanning pulse 11 is a monochromatic laser beam on the optical path portion 11a, as represented by the spectrum 34. The narrow line is centered on 1064 nm and has a FWHM of 0.5 nm.

The core 13 has nonlinear properties, such that the DCF 31 is a supercontinuum (SC) fiber. In other words, the scanning pulse 11 propagates through the core 13 of the double-clad optical fiber 31 which is configured to spread the spectrum of said scanning pulse 11 such that it is transformed from monochromatic to supercontinuum, as represented by the spectrum 36. The supercontinuum extends at least from 1400 nm to 1700 nm.

The length of the DCF 31 may be preferably 10 meters. Indeed, the length of the DCF 31 should be selected such that nonlinear effects in the DCF 31 are sufficient to get a supercontinuum from a monochromatic laser pulse.

One can get such a result by selecting a DCF 31 such that a ratio of a P×L/D is above a threshold equal to 250 W, wherein P denotes for a power peak at the entry of the multi-clad fiber, L denotes for a length of the multi-clad optical fiber, and D denotes for the diameter of the core 13.

The DCF 31 may be selected for instance in a set of Passive fibers referred on the optical component manufacturer Thorlabs® by the references P-6/125DC, P-10/125DC, P-20/400DC or P-25/250DC, which are optimized for coupling to active doped fibers for amplification. For instance, the diameters of the core 13, inner cladding 14 and outer cladding 15 may be selected in the following triplet values, in micrometers (μm): [diameter of (core, inner cladding, outer cladding)]=[(7, 125, 245), or (10, 125, 245) or (20, 400, 520) or (25, 250, 350)], wherein the core diameter specification refers to the far-field mode field diameter at 1060 nm. For instance, the NA of the core 13 is selected in [0.12, 0.08, 0.07].

In general, the DCF 31 may present a cladding geometry of the DCF 31 which is round. The DCF 31 may present a numerical aperture (NA) for the inner cladding 14 above or equal to 0.48. The DCF 31 may present a coating material is a low-index acrylate. The diameter of the inner cladding 14 may be equal to or higher as ten times the diameter of the core 13. The NA of the core 13 may be lower as or equal to ¼ of the NA of the inner cladding 14.

Prior to travel through the DCF 31, the scanning pulse 11 is amplified by the amplifying fiber 32, as represented by spectrum 35. Indeed, the scanning pulse 11 is required to have a sufficient power peak to enable the DCF 31 to apply nonlinear effects on the scanning pulse 11.

As one can see, the spectrum is more or less the same as the spectrum 35, but with an amplified power. For instance, the power peak is amplified by a factor 400.

The amplifying fiber 32 is an Ytterbium-doped (Yb-doped) fiber which is optically pumped as depicted by the symbol 10. The optical amplifying fiber 32 is fiber-coupled with the double-clad optical fiber 31. More precisely, one end of both the optical amplifying fiber 32 and the DCF 31 is meld with each other, such that the two optical fibers form a single long optical fiber.

The amplifying optical fiber is configured to amplify the optical power of the scanning beam 11, when optically pumped by an optical pump arrangement 10.

The amplifying fiber 32 may be preferably 5 meters long. Such a length enables the scanning pulse 11 to be enough pumped, from an unpumped peak power value around 250 mW up to a pumped peak power value higher than 100 W.

The amplifying fiber 32 may be selected in matching active fibers referred on the products of Thorlabs® by the references YB1200-6/125DC, YB1200-10/125DC, YB1200-20/400DC and respectively YB1200-25/250DC, which are compatible with the passive fibers described hereinabove (for instance YB1200-25/250DC is compatible with P-25/250DC as the core diameter and the inner cladding diameter have the same values).

In general, the amplifying fiber 32 is preferably selected in double-clad fibers, such that the amplifying fiber 32 has the same core diameter as the diameter of the core 13 of the DCF 31, and the same inner cladding diameter as the diameter of the inner cladding 14 of the DCF31. For instance, the inner cladding geometry is octagonal.

For instance, the diameters of the core, inner cladding and outer cladding may be selected in the following triplet values, in micrometers (μm): [diameter of (core, inner cladding, outer cladding)]=[(7, 125, 245), or (10, 125, 245) or (20, 400, 520) or (25, 250, 350)], for an octagonal cladding measured flat to flat, wherein the core diameter specification refers to the far-field mode field diameter at 1060 nm.

For instance, the NA of the core 13 is selected in [0.12, 0.08, 0.07]. The coating material of the outer cladding 15 may be low-Index Acrylate. The cladding NA may be equal to or above 0,46 or 0,48. The cladding absorption at the wavelength of pumping 920 nm may be comprised between 5.5 μm and 2.3 μm.

The scanning pulse 11 travel continues after the stage of the optical fiber arrangement 3, to the scanning unit 4. One can see schemes 37 and 38 of the spectrum of the return pulse 12 for each stage of propagation through the optical path in the sensing direction 7.

The scanning unit 4 comprises a tunable notch 9, in order to remove a narrow band centered on a selectable wavelength from the supercontinuum spectrum.

The optical path portion 12a is the portion of the optical path comprised between the scanning unit 4 and the notch 9 on the sensing direction 7. The optical path portion 12b is the portion of the optical path comprised between the notch 9 and the optical fiber arrangement 3.

As one can see, and for the only sake of illustration, the spectrum 38 of the return pulse 12 is represented with the assumption that the target 5 is a perfect plan mirror. The spectrum 39 is the same as the spectrum 38, but with the narrow band removed.

By selecting successive different wavelength from the supercontinuum, on can spectrally scan the target 5. In a variant, one can replace the notch 9 by a bandpass filter. However, advantageously, using a notch 9 instead of a bandpass filter enables to use a maximum of the return power from the target 5.

The scanning unit 4 further comprises a f/2 lens 43, and a scanning header 41 which is spatially orientable, as pictured by the arrow 42.

As one can see, the f/2 lens 43 is used on the optical paths 11c et 12b, in order to collimate the return pulses 12 back into the optical fiber arrangement 3. For instance, the f/2 lens may be selected in the lenses referred by the reference AC127-019-C of the manufacturer Thorlabs®. Such a lens is an achromatic doublet, anti-reflective coated in the range 1050 nm-1700 nm. The focal distance may be 19 mm and the diameter 1.27 cm.

The scanning header 41 comprises optical components for steering the scanning pulse 11 in an orientable direction, in order to enable the LiDAR to spatially scan the target 5.

The foregoing discussion disclosed and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

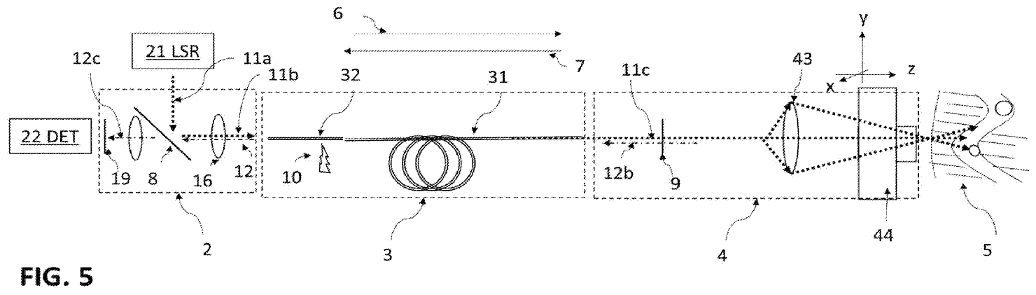

Namely, a light detecting system for medical applications, comprising an optical arrangement 1 according to a variant is represented with reference to FIG. 5. As one can see, the target 5 represented on FIG. 5 is a skin comprising a blood vein, which is imaged by the light detecting system.

Similarly to the example of FIG. 1, the light detecting system comprises a laser source 21 and a optical detector 22 arranged with a dichroic beamsplitter 8 in front of the same optical fiber arrangement 3. The laser source 21 and the optical detector 22 may operate for laser pulses in the short wave infrared (SWIR) range for instance.

As represented, the scanning unit may be different to the one of the optical arrangement 1 of the LiDAR of FIG. 1. Indeed, the scanning unit 4 comprises a lens arrangement for collimating the light a short focal distance lower than 5 cm on the target 5.

The scanning unit namely comprises a microscope head 44 which is moveable in the 3 dimensions. The microscope head 44 is configured to record its 3D position for each measured location of the target 5, such that the optical detector 22 may associate the 3D coordinates with a lighting measurement.

1-15. (canceled)

16. An optical arrangement for a light detecting system, the optical arrangement being configured:
to steer an illumination beam along an illumination optical path from a laser source to a target to be sensed, in a transmitting direction, and
to transmit a reflected beam along a return optical path from the target to an optical detector, in a receiving direction, wherein the reflected beam comprises a reflection of the illumination beam on the target,
the optical arrangement comprising:
a transceiver arrangement comprising a dichroic beamsplitter, the transceiver arrangement being configured for:
transmitting a source beam from the laser source to a first end of an optical fiber arrangement, in one way selected among: through or by reflection on the dichroic beamsplitter, and
transmitting the reflected beam from said first end of the optical fiber arrangement to the optical detector in the other way selected among: through or by reflection on the dichroic beamsplitter,
the optical fiber arrangement comprising a multi-clad optical fiber which comprises a core, at least one inner cladding, and an outer cladding; wherein
said core is arranged to receive the source beam having a first wavelength, such that the source beam propagates in the core in said transmitting direction, and
the core is further configured to generate a scanning beam from the source beam propagating in the core, wherein the scanning beam comprises at least a second wavelength which is different from the first wavelength, and
said at least one inner cladding is configured to receive the reflected beam, comprising the at least second wavelength, such that the reflected beam propagates in the inner cladding in said receiving direction,
a scanning unit optically coupled to a second end of the optical fiber arrangement, the scanning unit being configured to steer the scanning beam to said target, and to receive the reflected beam from the target.

17. The optical arrangement according to claim 16, wherein the light detecting system is a light detecting and ranging (LiDAR) system and the source beam is a pulsed laser beam.

18. The optical arrangement according to claim 17, wherein the source beam at the first end of an optical fiber arrangement is a monochromatic pulsed beam centered on the first wavelength, and having a full width at half maximum lower as 10 nm, preferably lower as 1 nm.

19. The optical arrangement according to claim 17, wherein the at least second wavelength is shifted from the first wavelength by at least 300 nm.

20. The optical arrangement according to claim 17, wherein the first wavelength is 1064 nm.

21. The optical arrangement according to claim 17, wherein the dichroic beamsplitter has a high transmittance for wavelength higher as 1100 nm and a high reflectivity for wavelengths lower as 1100 nm.

22. The optical arrangement according to claim 17, wherein the core is further configured to generate a supercontinuum in a range comprising the second wavelength.

23. The optical arrangement according to claim 17, wherein the supercontinuum comprises at least the spectral range of [1450 nm-1650 nm], preferably a larger spectral range, such as for instance [1400 nm-1700 nm].

24. The optical arrangement according to claim 18, wherein the multi-clad optical fiber is selected such that a ratio of a P×L/D is above a threshold equal to 250 W, wherein P denotes for a power peak of light of the monochromatic pulsed beam at one end of the multi-clad fiber, L denotes for a length of the multi-clad optical fiber, and D denotes for the diameter of the core of the multi-clad optical fiber.

25. The optical arrangement according to claim 17, further comprising a notch filter or a wavelength bandpass filter arranged on the return optical path.

26. The optical arrangement according to claim 25, wherein the notch filter or the wavelength bandpass filter is wavelength-tunable.

27. The optical arrangement according to claim 17, wherein the optical fiber arrangement further comprises an amplifying optical fiber coupled to the multi-clad optical fiber, such that the laser beam propagates in the amplifying optical fiber, wherein the amplifying optical fiber is configured to optically amplify the laser beam propagating in said amplifying optical fiber such that a ratio between an unamplified power peak and an amplified power peak of the laser beam is higher than 10, preferably higher than 1000.

28. The optical arrangement according to claim 27, wherein the amplifying optical fiber and the multi-clad optical fiber are optically coupled by a welding of the first end of the multi-clad fiber with an end of the amplifying optical fiber, in order to form a single optical fiber.

29. The optical arrangement according to claim 16, wherein the light detecting system is a spectral analysis and/or imaging system.

30. A vehicle comprising a LiDAR system comprising the optical arrangement according to claim 17.
